(19) United States
(12) Patent Application Publication
(10) Pub. No.: US 2007/0248088 A1
(43) Pub. Date: Oct. 25, 2007

(54) Method and apparatus for transmitting a multicast message

(76) Inventor: Seau Sian Lim, Swindon (GB)

Correspondence Address: Lucent Technologies Inc.;Docket Administrator - Room 3J-219, 101 Crawfords Corner Road, Holmdel, NJ, 07733-3030, US

(21) Appl. No.: 11/409,181

(22) Filed: Apr. 21, 2006

(51) Int. Cl. H04L 12/56; H04Q 7/00; H04J 3/26

(52) U.S. Cl. 370/390; 370/432; 370/328

(57) ABSTRACT

A method is provided of transmitting a multicast message in some of a set of cells of a network. The method comprises the steps of: (a) determining a first subset of cells in each of which resides at least one mobile terminal that subscribes to the multicast message service and is in an active state; (b) from the cells not in the first subset determining a second subset of cells in each of which resides at least one mobile terminal that subscribes to the multicast message service and is in an inactive state by the steps of: (i) in a cell sending an enquiry message as to whether there is/are mobile terminal(s) subscribing to the multicast message service and in an inactive state, (ii) receiving a reply from at least one such mobile terminal subscribing to the multicast message service and in an inactive state; (c) transmitting the multicast message in the first subset of the cells; and (d) transmitting the multicast message in the second subset of the cells.

### FIELD OF THE INVENTION

The present invention relates to telecommunications, in particular to wireless telecommunications.

### DESCRIPTION OF THE RELATED ART

Multicasting is the transmission of a message within a certain area so as to reach all of a selected group of user terminals. This area is known as a multicast service area. In the multicast service area, there may well be other user terminals present which are not in the selected group and so do not receive the message.

As shown in FIG. 1, the network broadcasts the message only in those cells that are considered by the network to possibly contain user terminals that are in the selected group. For example, the selected group might be user terminals belonging to subscribers to a multicast service that provides messages giving football results. A cell is a radio-coverage area served by an antenna of a base station.

The user terminals in the selected group listen to the multicast message in the sense of receiving and processing the multicast message sent over that control channel of the cell they are in currently. Conversely, user terminals that are not in the selected group do not listen to the multicast message sent in the control channel; in other words, they do not process that message for presentation to the user.

In some known systems, such as a Universal Mobile Telecommunications System (UMTS) systems, user terminals can be in various states. In some of these states, the location of the user terminal is not known by the network to cell level, but rather the user terminal location is only known to be within a group of several cells. In such a situation, the network then has to broadcast the multicast message to all cells that might contain a user terminal of the selected group, even though not all such cells contain a user terminal of the selected group. This is illustrated in FIG. 1. The network 10 transmits the multicast message 12 to all of the cells 14,16,18, where users 20, 22 of the selected group may be located. For example, as shown in FIG. 1, a first user 20 has a location known to be in cell 14; however a second user 22 is known to be in either cell 16 or cell 18. Of course, there can be many more user terminals and many more cells in the system than illustrated in FIG. 1.

As the network is transmitting the multicast message to cells that contain no user terminals intended to receive that message, radio resources are wasted. In particular, there is waste of transmit power and channelisation codes, which might otherwise be used for other services, such as other multicast services. Another disadvantage is increased radio interference within and between cells, namely so-called intra-cell and inter-cell interference. A further disadvantage is that scarce multicast scheduling resources are used inefficiently, as multicast messages can typically be broadcast only at certain times in each cell.

It is known to transfer user terminals into active states for which location of the user terminal becomes known to cell level. However, this causes an increase in control signalling traffic between the user terminal and network, which causes a consequential increase in interference, and is a waste of radio resources.

### SUMMARY OF THE INVENTION

The inventor found a way to transmit only to cells in the multicast service area that contain user terminals that subscribe to the multicast service, irrespective of the states of the user terminals.

An example of the present invention is a method of transmitting a multicast message in some of a set of cells of a network. The method comprises the steps of:

(a) determining a first subset of cells in each of which resides at least one mobile terminal that subscribes to the multicast message service and is in an active state;

(b) from among those cells that lie outside the first subset, determining a second subset of cells in each of which resides at least one mobile terminal that subscribes to the multicast message service and is in an inactive state by the steps of:

(i) in a cell, sending an enquiry message as to whether there are mobile terminals subscribing to the multicast message service and in an inactive state,

(ii) receiving a reply from at least one such mobile terminal subscribing to the multicast message service and in an inactive state;

(c) transmitting the multicast message in the first subset of the cells; and

(d) transmitting the multicast message in the second subset of the cells.

### BRIEF DESCRIPTION OF THE DRAWINGS

An embodiment of the present invention will now be described by way of example and with reference to the drawings, in which:

FIG. 1 is a diagram illustrating a telecommunications system using a known multicasting technique (PRIOR ART),

FIG. 2 is a diagram illustrating a telecommunications system using a multicasting technique according to the present invention, and

FIG. 3 is a diagram illustrating the system shown in FIG. 2 in more detail,

FIG. 4 is a diagram illustrating the messages between the mobiles and network in the system shown in FIGS. 2 and 3, and

FIG. 5 is a flow chart illustrating operation of the system shown in FIG. 2 and 3.

The drawings are not to scale but are schematic representations.

### DETAILED DESCRIPTION

When considering a known system, the inventor realised that if no active mobiles subscribing to a multicast service were identified as being within a cell, then in deciding whether or not to broadcast the service in that cell, an enquiry could be made as to whether there were one or more mobiles subscribing to the service in that cell in a less active state for which location was not normally known at cell level.

User Terminal States

In a Universal Mobile Telecommunications System (UMTS) network, a mobile user terminal can take, at any time, any one of five states. There are four so-called radio resource control (RRC) states and one idle mode state.

In three of the RRC states, the network knows the location of the user terminal to cell level. These three states are:

Cell-Dedicated Channel state, often referred to as Cell-DCH, which is when the user terminal is connected in a call over a dedicated channel,

Cell-Forward Access Channel state, often referred to as Cell-FACH, which is when the user is connected in a call but using a shared channel, and Cell-Paging Channel state, often referred to as Cell-PCH, which is when the user terminal is not call-connected but is “locked-on” to the cell.

On the other hand, in the two other states the network only knows the location of the user terminal to a precision (“granularity”) of several cells. One of these states is UTRAN Registration Area Paging Channel, where UTRAN means UMTS Terrestrial Radio Access Network. This state is often referred to as URA-PCH state. The other of these two states is Idle Mode, in which the user terminal location is known to Routing Area level if the network is packet-switched, or to Location Area level if the network is circuit-switched.

The Telecommunications System

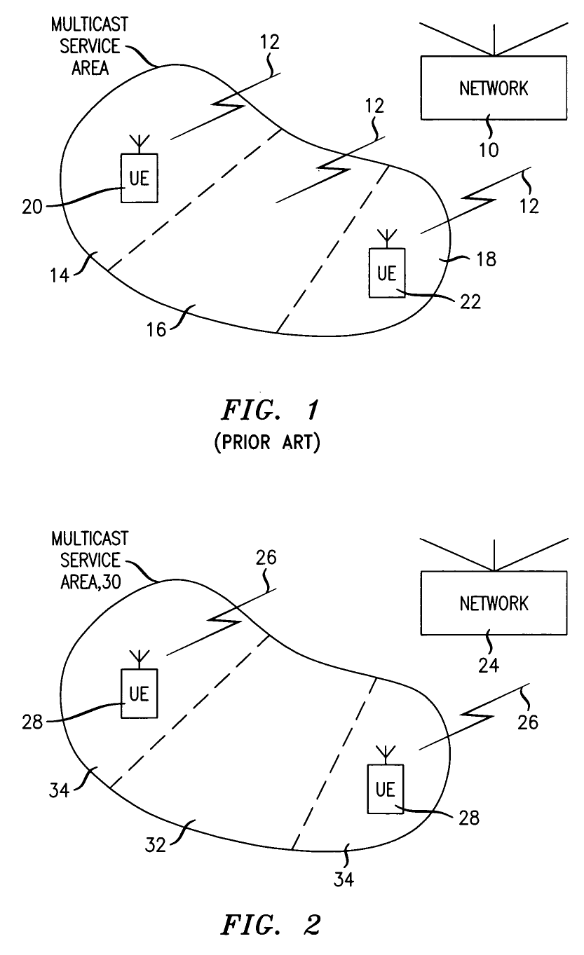

As shown in FIG. 2, a network 24 transmits multicast messages 26 only in cells 34 within the multicast service area 30 that contain user terminals 28 that subscribe to the multicast service, irrespective of the states of the user terminals 28. The locations of the subscribing user terminals are identified to cell-level.

As shown in this FIG. 2 example, one cell 32 in the multicast service area 30 is identified as including no user terminals subscribing to the multicast service.

The Telecommunications System in More Detail

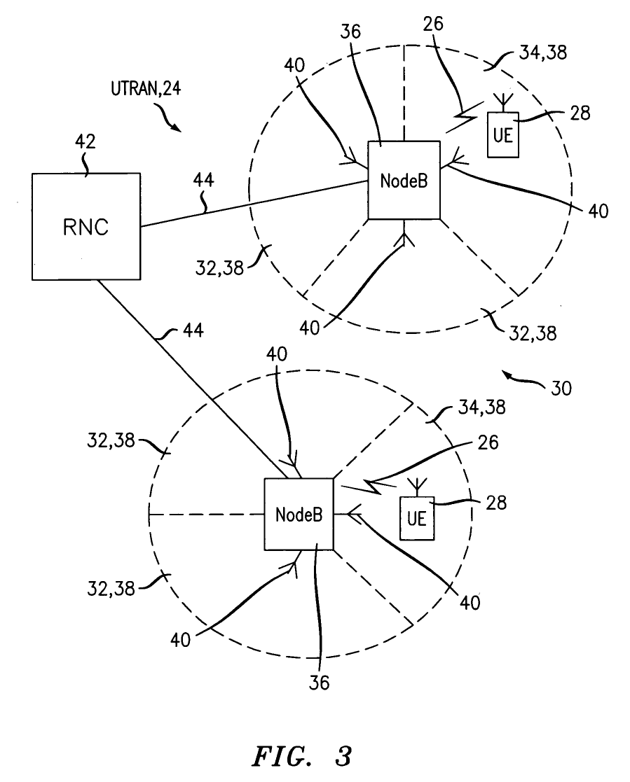

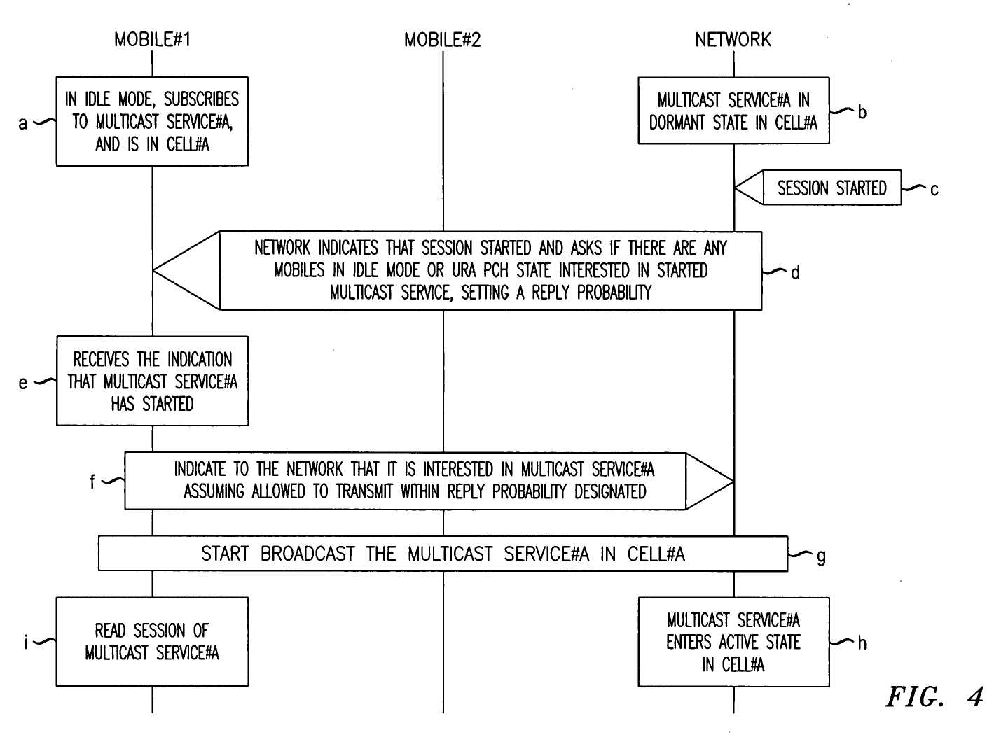

The system is shown in more detail in FIG. 3, and consists of the network 24 and user terminals 28.

The network 24 is a Universal Mobile Telecommunications System (UMTS) terrestrial access network (UTRAN) , which is a type of wideband code division multiple access (CDMA) network for mobile telecommunications. The UTRAN network is basically as shown in FIG. 3. Only one radio network controller and two base stations of the UTRAN network 2 are shown for simplicity. As shown in this Figure, the UTRAN network 24 includes base stations 36. In the Figure, each of the base stations 36 is also designated “Node B” in accordance with UMTS terminology.

A cell, also referred to as a sector, is the radio-coverage area served by a corresponding antenna of a base station. Each base station typically has three cells 38, each covered by one of three directional antennas 40 angled at 120 degrees to each other in azimuth. Each radio network controller (RNC) 42 typically controls several base stations 36 and hence a number of cells 38. A base station 36 is connected to its controlling radio network controller (RNC) 42 via a respective interface 44 known as an IuB interface. In use, a mobile user terminal 28 (often referred to as User Equipment (UE) in UMTS terminology) communicates with a serving radio network controller (RNC) 42 via at least one cell 38 of at least one base station 36. In that way, the mobile user terminal communicates with the UTRAN network 24.

The cells 38 make up the multicast service area 30 that is shown in FIG. 2. The multicast message 26 is only broadcast in those particular cells 34 of the cells 38 that include a mobile terminal 28 that subscribes to the multicast service. Of course those particular cells 32 of the cells 38 in which the multicast message 26 is not broadcast, may contain further user terminals not subscribing to that multicast service; such further cells are not shown in FIGS. 2 and 3 for simplicity.

Locating User Terminals Subscribing to the Multicast Service

The network 24, specifically in the radio network controller 42, keeps records (not shown) of multicast services and the state of their application to cells. These records either indicate (a) that there are user terminals subscribing to the multicast service within the cell and hence the multicast message should be broadcast in that cell, or (b) that there are no user terminals subscribing to the multicast service within the cell and hence the multicast message should not be broadcast in that cell. The first-mentioned (a) of these two cell states is known as Active state. The other (b) is known as Dormant state.

If a session of multicast service has started, or is going to start, then the question is considered of which cells to select as those in which to broadcast the multicast messages.

Firstly, cells are identified that are both in the multicast service area and contain at least one user terminal that both subscribes to the multicast service and is in a state (Cell-DCH, Cell-FACH, or Cell-PCH) allowing the location of the mobiles to be known to cell level. These cells are selected to broadcast the multicast messages and are recorded as being in the Active state.

In each remaining cell in the multicast service area, the network periodically determines whether there are any user terminals in URA-PCH or Idle Mode states which are subscribers to the multicast service and lie within that cell. These determinations are described in more detail in the next section below. If such a user terminal is identified in the cell, that cell is also selected to broadcast the multicast messages by being recorded as being in the Active state.

The monitoring is periodic, in other words determinations are repeated. Moreover, some user terminals are moving. Accordingly, it often happens that upon a further determination, a user terminal interested in the multicast service is no longer detected in a cell. The broadcast of the multicast message in that cell is then stopped, often part-way through the message transmission, and that cell is recorded by the network as going into Dormant state in respect to that multicast service.

Determining Whether a Cell Contains a User Terminal in URA-PCH or Idle Mode States that are Subscribers to the Multicast Service

As shown by way of example in FIG. 4, user terminal “Mobile#1” is a subscriber to a multicast service#A currently in cell#A (step a), but as a session of this service has not yet started, cell#A is in a Dormant state (step b) as regards that service.

When the session starts (step c), those cells with user terminals subscribing to the service and in Cell-DCH, Cell-FACH, or Cell-PCH state have informed (not shown) the network of their location to cell-level, hence the network knows to broadcast the multicast service session messages in those cells.

As for those cells in the multicast service area which do not contain user terminals that both subscribe to the service and are in Cell-DCH, Cell-FACH, or Cell-PCH state, the networks asks (step d) each whether they contain any user terminals subscribing to the service and also in URA-PCH or idle mode states. The network sets a reply probability of e.g., 30%, to avoid too much unnecessary signalling. This means that when such a user terminal in Cell #A receives (step e) the indication that the multicast service session has started, the user terminal generates a random fractional number in the range 0 to 1. Only if that number is within the range 0 to 0.3, will the user terminal send a message (step f) to inform the network that the user terminal wishes to receive the multicast service#A in cell #A.

Upon receiving an indication from any interested mobile in a cell, such as mobile #1, the network broadcasts (step g) the session to that cell. In this example the particular cell is Cell #A. The network notes the particular cell as transiting to the Active state (step h). The interested mobile or mobiles in that cell receives/receive the multicast service (step i).

For as long as the multicast service#A session is on-going, the network periodically sends a message asking whether Mobile #1 or any other mobile in that cell (e.g cell#A) is still interested in multicast service #A. (This is akin to step d shown in FIG. 4.) If no appropriate reply (akin to step f shown in FIG. 4) is received, then the network stops broadcast of the multicast service in that cell, and the cell enters the Dormant state in respect to that multicast service.

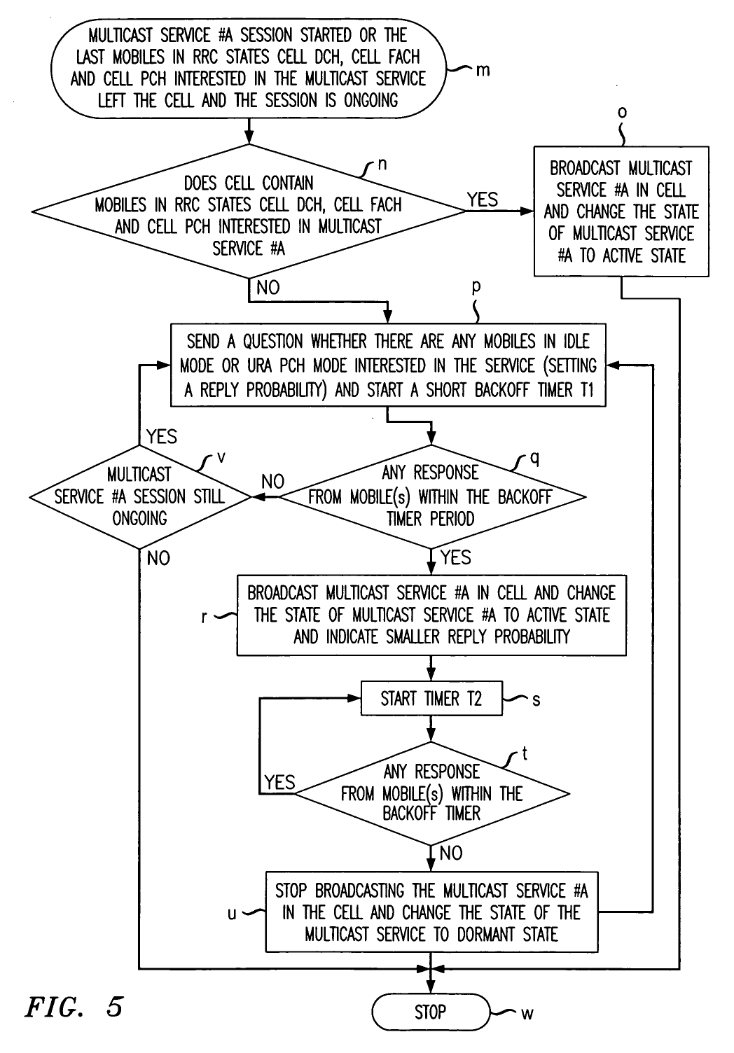

The functionality shown in FIG. 4 is shown again in slightly more detail in FIG. 5. FIG. 5 shows the operations involved in a cell determining whether mobiles in the cell wish to receive a multicast service and transiting between Active State and Dormant State for the multicast service. This is as follows:

At the start of a multicast service session, the network proceeds to make a determination (step n) whether the cell contains mobiles in Radio Resource Control (RRC) states Cell DCH, Cell FACH or Cell PCH that are interested in that particular multicast service (e.g. multicast service#A). The network proceeds likewise in the event that it has determined that there are no longer any mobiles interested in the multicast service and in an active state, specifically Radio Resource Control (RRC) states Cell DCH, Cell FACH or Cell PCH in the cell but the multicast service session is on-going (step m).

If yes, then (step o) that multicast service is broadcast in that cell and the state of that cell as recorded in the network is updated from Dormant state to Active state for that service.

On the other hand, if no, then the network sends (step p) its question whether there are any mobiles in a non-call-connected state, namely Idle Mode or URA PCH state interested in the multicast service, setting a reply probability for such mobiles of say 30% as discussed above. in respect of FIG. 4, and starts a timer of preset short interval Ti (which can be considered a short “back-off” or “time-out” period). A typical value of T1 might be in the range five to ten seconds. Those mobiles that do send a reply can be considered as being in a “signalling group”.

A determination is then made (step q) in the network as to whether a positive response is received before the short interval T1 ends.

At step q if yes, then (step r) that broadcast of the multicast service in that cell is started and the state of that cell recorded in the network is updated from Dormant state to Active state for that multicast service. Also, the network then sends an indication of a lower (more stringent) reply probability. A timer is started (step s) in the network of a preset interval T2 longer than T1. T2 can be considered a longer “back-off” or “time-out” period. A typical value of T2 might be 1 to 5 minutes.

At step q, if no, then after the shorter time period T1 has expired, those mobiles currently interested in the multicast service but not in the last signalling group will recalculate the respective random fraction to determine whether they are in the signalling group for the current time period T1. This is done repeatedly for subsequent consecutive T1 periods. In each T1 period, those mobiles currently in the signalling group send replies until a positive response is received (yes at step q).

The network then determines (step t) whether such a further reply is received within the longer period T2 from any mobile terminal in the cell. If yes, then the multicast session is continued in that cell and then the timer of the longer period T2 is restarted (this is shown as a return to step s in the flow-chart shown in FIG. 5). If no, then (step u) broadcast of the multicast service in that cell is terminated and the state of the cell for that service as recorded in the network is updated to Dormant State.

At step q if no, then the network determines (step v) whether the multicast service session is still on-going. If yes, a return is made to step p. If no, the procedure stops (step w).

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. A method of transmitting a multicast message in some of a set of cells of a network, the method comprising the steps of:
determining a first subset of cells in each of which resides at least one mobile terminal that subscribes to the multicast message service and is in an active state;
from the cells not in the first subset, determining a second subset of cells in each of which resides at least one mobile terminal that subscribes to the multicast message service and is in an inactive state by the steps of:
(i) in a cell, sending an enquiry message as to whether there are mobile terminals subscribing to the multicast message service and in an inactive state, and
(ii) receiving a reply from at least one such mobile terminal subscribing to the multicast message service and in an inactive state;
transmitting the multicast message in the first subset of the cells; and
transmitting the multicast message in the second subset of the cells.

2. A method according to claim 1, in which the enquiry message includes an indication that only a fraction of those mobile terminal subscribing to the multicast message service and in an inactive state are to reply within a predetermined period.

3. A method according to claim 1, in which the indication corresponds to a fraction between 0 and 1, and the mobile includes a pseudo-random number generator which provides a fractional value between 0 and 1 for each predetermined period, and upon the fractional value being less than the indicated fraction, the mobile sends such a reply.

4. A method according to claim 1, in which in a cell the enquiry is repeated until the reply is received.

5. A method according to claim 1, in which whilst the multicast message is ongoing, the multicast message transmission in a cell is terminated upon no reply from a mobile terminal subscribing to the multicast message service being received for more than a predetermined time.

6. A method according to claim 1, wherein the network is a code division multiple access radio network.

7. A method according to claim 6, wherein the network is a Universal Mobile Telecommunications System (UMTS) network, and the inactive state is any of URA-PCH state or idle mode.

8. A network for wireless telecommunications comprising a set of cells, each of which includes a base station; the network being operative to determine a first subset of the cells in each of which resides at least one mobile terminal that subscribes to a multicast message service and is in an active state;
the network also being operative to determine from the cells not in the first subset a second subset of the cells in each of which resides at least one mobile terminal that subscribes to the multicast message service and is in an inactive state by:
a base station in a cell sending an enquiry message as to whether there are mobile terminals subscribing to the multicast message service and in an inactive state, and
the base station in the cell receiving a reply from at least one such mobile terminal subscribing to the multicast message service and in an inactive state;
the network being operative to transmit the multicast message in the determined first subset of the cells and in the determined second subset of the cells.
